(19) United States
(12) Patent Application Publication
(10) Pub. No.: US 2010/0103670 A1
(43) Pub. Date: Apr. 29, 2010

(54) ILLUMINANT DEVICE AND LIGHT REFLECTING SHADE THEREOF

(76) Inventors: Han-Chung HSU, Taoyuan Hsien (TW); Nai-Yueh LIANG, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/345,122

(22) Filed: Dec. 29, 2008

(30) Foreign Application Priority Data
Oct. 27, 2008 (TW) 097141113

(51) Int. Cl. F21V 29/00; F21V 1/00; F21V 31/00

(52) U.S. Cl. 362/235; 362/341; 362/296.01; 362/294; 362/267

(57) ABSTRACT

This invention provides an illuminant device and its light reflecting shade for reflecting a light emitted from a light source. Such light reflecting shade includes a plurality of reflecting sheets forming a conoid-like structure with a plurality of reflecting planes, a first side and a corresponding second side. The light source is disposed at the first side and the second side is a light emitting side.

### CROSS REFERENCE TO RELATED APPLICATIONS

This Non-provisional application claims priority under 35 U.S.C. §119(a) on Patent Application No(s). 097141113 filed in Taiwan, Republic of China on Oct. 27, 2008, the entire contents of which are hereby incorporated by reference.

### BACKGROUND OF THE INVENTION

1. Field of Invention

The present invention relates to an illuminant device and its light reflecting shade and, in particular, to a light reflecting shade having a high directivity and capable of concentrating the light in the specified area.

2. Related Art

The mercury lamp, high-pressure sodium (HPS) lamp, or metal halide lamp with a hemispheric light shade are commonly used as the conventional street lamp. The conventional light shade reflects the light from the back or from the side to the front through the spherical reflecting surface. Since the light shade merely reflects the light to the front without directivity, it cannot effectively concentrate the light in the specified area such that the utilization efficiency of the lamp is low and the undesired scattering light is produced. These will cause an influence on the drivers, pedestrians, and even surrounding building.

### SUMMARY OF THE INVENTION

The present invention is to provide an illuminant device and its light reflecting shade, particularly a light reflecting shade having a high directivity and capable of concentrating the light in the specified area.

To achieve the above, a light reflecting shade according to the present invention is used to reflect the light emitted from a light source. Such light reflecting shade includes a plurality of reflecting sheets forming a conoid-like structure with a plurality of reflecting planes, a first side and a corresponding second side. The light source is disposed at the first side and the second side is a light emitting side.

The first side is open or closed for disposing the reflecting sheet. The first side is parallel or unparallel with the second side. The area of the second side is greater than that of the first side, and the first side and the second side have respectively an ellipse, a circle, a rectangle, a polygon or an irregular profile. The material of the reflecting sheet is aluminum or metal. The surface of the reflecting sheet includes a high reflective material formed by plating or coating, and the high reflective material is preferably silver. The conoid-like structure is formed by bending the single reflecting sheet or assembling the plurality of reflecting sheets together.

The reflecting planes are disposed inside the conoid-like structure formed by one or more portions, and the slope of one reflecting plane of one portion is different from that of corresponding reflecting plane of another portion. The conoid-like structure is formed as a single piece, or is formed by assembling the plurality of portions together. The central axis of the first side is aligned or not aligned with the central axis of the second side.

To achieve the above, the illuminant device according to the present invention is arranged and assembled by at least one illuminant module. Each illuminant module includes at least one light source, at least one light reflecting shade, a substrate, and a heat sink. The light reflecting shade is disposed corresponding to the light source and includes at least one reflecting sheet to form a conoid-like structure. The conoid-like structure has a plurality of portions, a first side and a second side. Each portion comprises a plurality of reflecting planes. The light source is disposed at the first side and the second side is a light emitting side. The light source is disposed on the substrate and the heat sink is disposed under the substrate for heat dissipation.

The light source is preferably a light emitting diode (LED). The illuminant module further includes a power connection line, a housing, and a rubber pad. The power connection line is electrically connected to the light source. The material of the housing is preferably aluminum, and the housing is connected to the heat sink for covering the light source, substrate, and light reflecting shade. The housing further includes a transparent plate, which is preferably made of glass and disposed above the light source for passing the light therethrough. The rubber pad is disposed between the housing and the heat sink for providing the water-proof function to the light source.

The above-mentioned illuminant modules are arranged and assembled at the same plane or different planes, and are preferably assembled in an arc shape. The above-mentioned illuminant device further includes a frame for disposing the illuminant modules thereon. The illuminant device is preferably a street lamp, a searchlight or a projection lamp.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a perspective view of a light reflecting shade according to a preferred embodiment of the present invention;

FIG. 1B is a top view of FIG. 1A;

FIG. 1C is a side view of FIG. 1A;

FIG. 2A is a schematic diagram of optical paths of a light reflecting shade according to a preferred embodiment of the present invention;

FIG. 2B is a distribution diagram of light angles of a light reflecting shade according to a preferred embodiment of the present invention;

FIG. 3A is a top view of a light reflecting shade according to another preferred embodiment of the present invention;

FIG. 3B is a side view from a shorter side of the rectangular light reflecting shade in FIG. 3A;

FIG. 3C is a side view from a longer side of the rectangular light reflecting shade in FIG. 3A;

FIG. 4A is an exploded view of an illuminant module according to a preferred embodiment of the present invention;

FIG. 4B is a perspective view of the assembled illuminant module shown in FIG. 4A; and

FIGS. 5A and 5B are schematic diagrams of an illuminant device according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

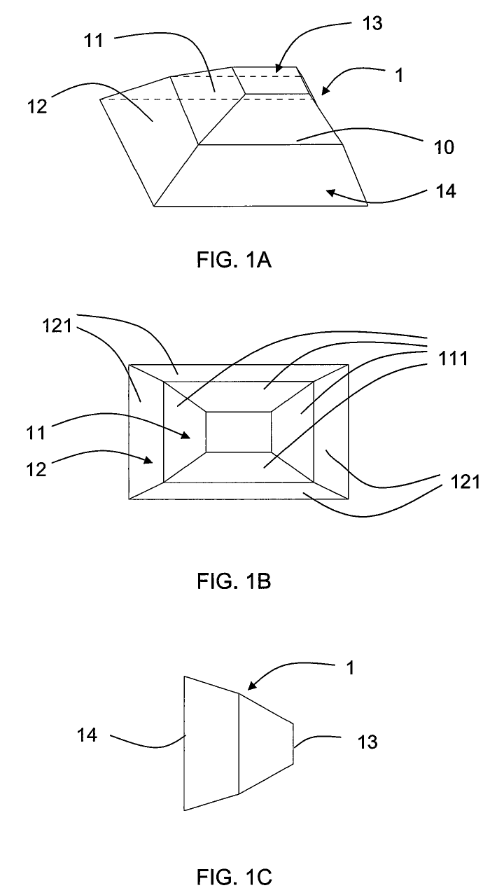

FIGS. 1A to 1C show a light reflecting shade according to a preferred embodiment of the present invention. FIG. 1B is a top view of FIG. 1A and FIG. 1C is a side view of FIG. 1A. The light reflecting shade includes a plurality of reflecting sheets 10 assembled together to form a conoid-like structure 1, or a single reflecting sheet bent to form a conoid-like structure 1. The conoid-like structure 1 has a first portion 11, a second portion 12, a first side 13 and a corresponding second side 14. The first side 13 is an open side, and the light source is disposed at the first side. The first side 13 can also be a close end. The second side 14 is a light emitting side. The first portion 11 and the second portion 12 are stacked together to form the conoid-like structure 1. The first conoid-like portion 11 and the second portion 12 are respectively include a plurality of reflecting planes 111, 121. The first side 13 and the second side 14 can be respectively an ellipse, a circle, a rectangle, a polygon or an irregular shape to meet the real requirement. The first side 13 and the second side 14 are parallel or unparallel.

The slope of one reflecting plane 111 of the first portion 11 is different from that of corresponding reflecting plane 121 of the second portion 12. The conoid-like structure 1 is formed as a single piece by the first portion 11 and the second portion 12, or is formed by assembling the first portion 11 and the second portion 12 together. The central axis of the first side 13 can be aligned or not aligned with the central axis of the second side 14.

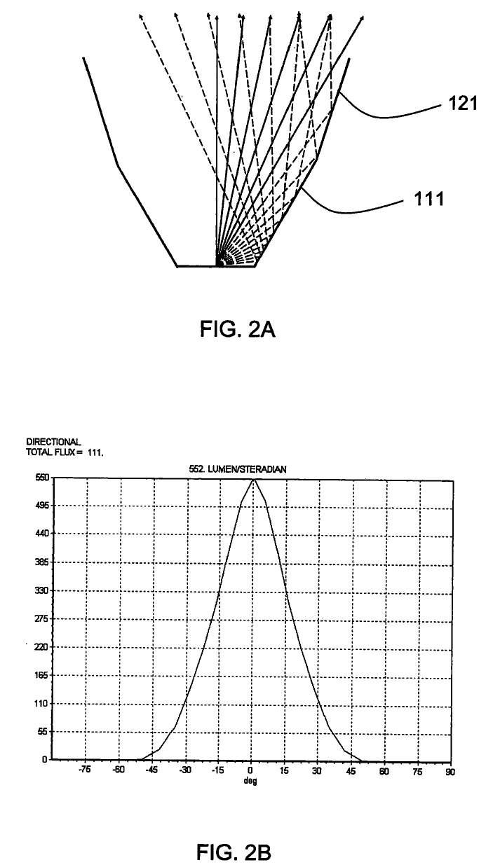

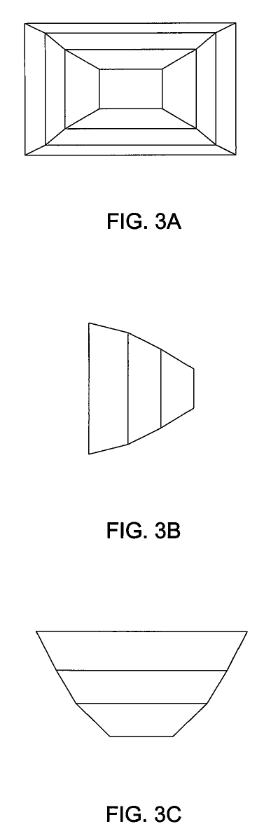

Accordingly, each side of the conoid-like structure 1 includes two reflecting planes 111, 121 with various slopes so as to reflect more angles of light and concentrate the light in the specified area and angle as shown in FIG. 2A. Otherwise, the reflecting shade of the present invention can reduce the light-emitting angle and concentrate the light angle distribution as shown in FIG. 2B. Certainly, the conoid-like structure can be formed by more than two portions as shown in FIG. 3A to 3C.

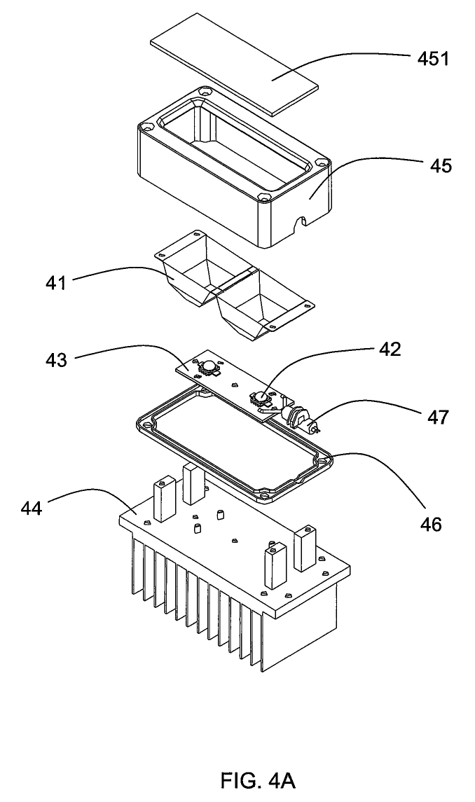

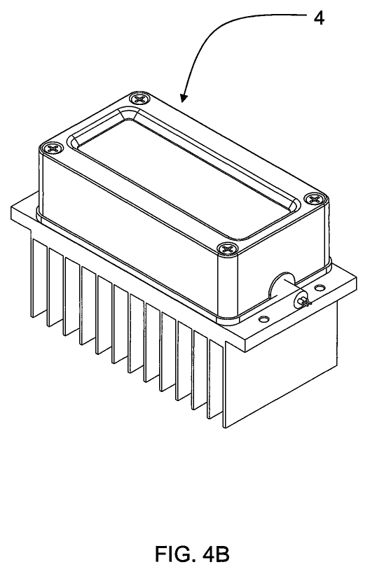

With reference to FIGS. 4A and 4B, the illuminant module 4 includes a light reflecting shade 41, a light source 42, a substrate 43, a heat sink 44, a housing 45, a transparent plate 451, a rubber pad 46, and a power connection line 47. The light reflecting shade 41 disposed corresponding to the light source 52 includes at least one reflecting sheet. Each light reflecting shade 41 has a first side and a second side. The light source 42 is disposed at the first side and the second side is a light emitting side. The light reflecting shade is a conoid-like structure formed by two or more portions with a plurality of reflecting planes, and the slope of one reflecting plane of one portion is different from that of corresponding reflecting plane of another portion. The light source 42 is disposed on the substrate 43, and the heat sink 44 is disposed under the substrate 43 for heat dissipation. The housing 45 connected to the heat sink 44 for covering the light source 42, the substrate 43 and light reflecting shade 41 is made of aluminum. A transparent plate 451 is disposed above the housing 45 for passing the light therethrough. A thermally conducting material can be attached to the surface of the substrate 43.

The light source 42 is a light emitting diode (LED) electrically connected to the power connection line 47. The rubber pad 46 is disposed between the housing 45 and the heat sink 44 for water-proof function. The light reflecting shade 41 is made of aluminum and a high reflective material on a surface thereof formed by plating or coating. Such high reflective material is preferably silver.

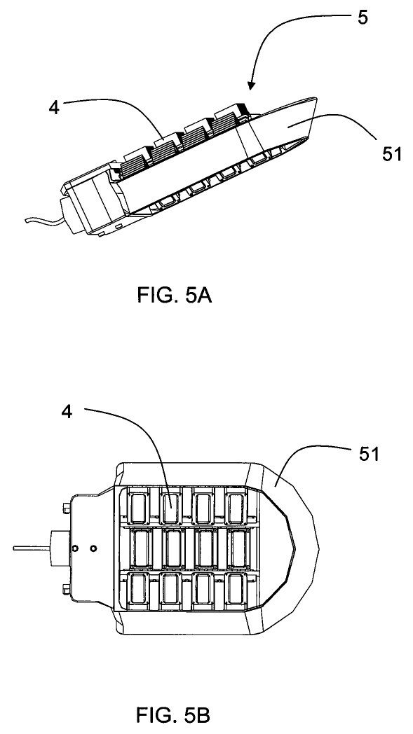

With reference to FIGS. 5A and 5B, the illuminant device includes an annular frame 51 and a plurality of illuminant modules 4 in FIG. 4B disposed on the annular frame. The plurality of illuminant modules 4 are arranged and assembled at the same plane or different planes. In one embodiment of the present invention, the illuminant modules 4 are arranged in an arc shape having a three-row structure. The illuminant modules 4 in the central row are arranged horizontally, and the other two rows lean toward the center in an angle and hence an arc shape is formed. The illuminant device 5 is preferably a street lamp, searchlight or projection lamp.

To sum up, the illuminant device and its light reflecting shade have a plurality of reflecting planes at the same side of the conoid-like structure. Therefore, the light reflecting shade can achieve high directivity and concentrate the light in the specified area and angle. The utilization efficiency of the light device can be enhanced by concentrating the light. With a uniform luminance, the light device enhances the utilization efficiency and reduces the undesired scattering light, hence decreasing the number of the light sources so as to lower the cost.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A light reflecting shade for reflecting a light emitted from a light source, comprising:
at least one reflecting sheet forming a conoid-like structure, wherein the conoid-like structure comprises a plurality of portions with a plurality of reflecting planes, a first side and a second side, the light source is disposed at the first side, and the second side is a light emitting side.

2. The light reflecting shade according to claim 1, wherein the first side or the second side has an ellipse, trapezoid, circle, rectangle, polygon or irregular profile, and the first side is open or closed.

3. The light reflecting shade according to claim 1, wherein the area of the second side is greater than that of the first side, and the first side and the second side are parallel or unparallel.

4. The light reflecting shade according to claim 1, wherein the reflecting sheet is made of aluminum or metal and has a high reflective material formed by plating or coating on a surface thereof.

5. The light reflecting shade according to claim 1, wherein the conoid-like structure is formed by bending the single reflecting sheet or assembling the plurality of reflecting sheets together.

6. The light reflecting shade according to claim 1, wherein the reflecting planes are disposed inside the conoid-like structure.

7. The light reflecting shade according to claim 1, wherein the slope of one reflecting plane of one portion is different from that of corresponding reflecting plane of another portion.

8. The light reflecting shade according to claim 1, wherein the conoid-like structure is formed as a single piece, or is formed by assembling the plurality of portions together.

9. The light reflecting shade according to claim 1, wherein the central axis of the first side is aligned or not aligned with the central axis of the second side.

10. An illuminant device assembled by at least one illuminant module, the illuminant module comprising:
at least one light source;
at least one light reflecting shade disposed corresponding to the light source and comprising at least one reflecting sheet to form a conoid-like structure, wherein the conoid-like structure comprises a plurality of portions with a plurality of reflecting planes, a first side and a second side, the light source is disposed at the first side, and the second side is a light emitting side; and
a substrate for disposing the light source thereon.

11. The illuminant device according to claim 10, wherein the illuminant module further comprises a housing for covering the light source, the substrate and the light reflecting shade.

12. The illuminant device according to claim 11, wherein the housing further comprises a transparent plate disposed on an optical path of the light source for passing the light therethrough.

13. The illuminant device according to claim 12, wherein the material of the housing is aluminum, and the material of the transparent plate is glass.

14. The illuminant device according to claim 10, wherein the illuminant module further comprises a heat sink disposed at one side of the substrate for dissipating heat of the light source.

15. The illuminant device according to claim 14, wherein the illuminant module further comprises a rubber pad disposed between the housing and the heat sink for providing a water-proof function.

16. The illuminant device according to claim 10, wherein the plurality of illuminant modules are arranged and assembled at the same plane, different planes or in arc shape.

17. The illuminant device according to claim 10, further comprising a frame for disposing the plurality of illuminant modules thereon.

18. The illuminant device according to claim 10, wherein the illuminant device is a street lamp, a searchlight or a projection lamp.

19. The illuminant device according to claim 10, wherein the light source is a light emitting diode (LED), and the illuminant module comprises a power connection line electrically connected to the light source.

20. The illuminant device according to claim 10, wherein a heat conducting material is attached to the surface of the substrate.
